(19) United States
(12) Patent Application Publication
(10) Pub. No.: US 2024/0344989 A1
(43) Pub. Date: Oct. 17, 2024

(54) IMPROVEMENTS IN OR RELATING TO A METHOD OR AN APPARATUS FOR DETECTING AN INTERACTION BETWEEN A BIOLOGICAL ENTITY AND A MOLECULE

(71) Applicant: LIGHTCAST DISCOVERY LTD, Cambridge, Cambridgeshire (GB)

(72) Inventors: Thomas Henry ISAAC, Cambridge, Cambridgeshire (GB); Emma HEAD, Cambridge, Cambridgeshire (GB); Aya PELLING, Cambridge, Cambridgeshire (GB); William DEACON, Cambridge, Cambridgeshire (GB); Cameron FRAYLING, Cambridge, Cambridgeshire (GB)

(73) Assignee: LIGHTCAST DISCOVERY LTD, Cambridge, Cambridgeshire (GB)

(21) Appl. No.: 18/577,441

(22) PCT Filed: Jul. 8, 2022
(86) PCT No.: PCT/GB2022/051763

§ 371 Date: Jan. 8, 2024

(30) Foreign Application Priority Data
Jul. 9, 2021 (GB) 2109969.2

(51) Int. Cl. G01N 21/64; B01L 3/00

(52) U.S. Cl. CPC G01N 21/6486; B01L 3/502715; B01L 3/502753; B01L 3/502784; B01L 2200/0652; B01L 2300/0819; B01L 2300/0867

(57) ABSTRACT

A method of detecting the interactions between a biological entity and a molecule, the method comprising providing an array of first microdroplets into a microfluidic chip; wherein each microdroplet contains at least one bead and each bead having a bound photocleavable molecule; providing an array of second microdroplets into the microfluidic chip; wherein each microdroplet contains at least one biological entity; holding the entire first and second arrays of microdroplets; illuminating at least a subset of the first microdroplets containing at least one bead with an illumination source configured to photo-cleave the molecule; subsequently merging at least one subset of the first array of microdroplets with at least one subset of the second microdroplets to form an array of merged microdroplets; and detecting a change in an optical signal from the merged microdroplets using an optical system to indicate the interactions between the biological entity and the molecule. An apparatus for detecting the interaction between a biological entity and a molecule is also provided.

The present invention relates to a method for detecting an interaction between a biological entity and a molecule. More particularly, the present invention relates to a method for detecting a change in an optical signal from a microdroplet using an optical system to indicate the interactions between the biological entity and the molecule. The present invention also provides an apparatus for detecting an interaction between a biological entity and a molecule.

### BACKGROUND

Conventional high-throughput screening (HTS) is a method for scientific experimentation especially used in drug discovery and relevant to the fields of biology and chemistry. HTS generally uses automated equipment to rapidly test thousands to millions of samples for biological activity at the model organism, cellular, pathway, or molecular level. In its most common form, HTS is an experimental process in which 103-106 small molecule compounds of known structure are screened in parallel. Other substances, such as chemical mixtures, natural product extracts, oligonucleotides, peptides and antibodies, may also be screened.

A subset of the HTS method is a DNA-encoded library (DEL) screening method. A DEL is a collection of small molecules covalently linked to DNA that has unique information about the identity and the structure of each library member. A DNA-encoded chemical library (DEL) is broadly adopted by major pharmaceutical companies and used in numerous drug discovery programs. The application of the DEL technology is advantageous at the initial period of drug discovery because of reduced cost, time, and storage space for the identification of target compounds.

Further miniaturisation of high throughput screening techniques aims to move away from plate based assays to further reduce the cost of space, reagents, consumables and target materials. Screens based on DNA-encoded chemical libraries are moving towards bead bound libraries that can be incorporated within a microfluidic device. A bead-bound library comprises a large population of micro-scale carrier beads which act as binding substrates for drug compounds. As well as a single drug compound each bead carries one or more copies of a synthetic DNA tag; the DNA sequence of the synthetic tag encodes the identity of the drug compound associated with that bead. In some cases, there may be a set of several different DNA tags on each bead, with the presence of each tag indicating completion of a particular step in the synthesis process.

In order to assay the compounds against cells or other biological entities, it is necessary to release the compounds from the beads. To this end compounds may be retained on the beads using a photo-cleavable linker molecule. When this linker molecule is irradiated with light of the correct wavelength and fluence for a suitable duration the linker breaks, releasing the compound from the bead in to the surrounding solution.

The DEL screening method can be carried out within a microfluidic device in order to enable functional screens of DNA-encoded compound beads. Some devices can carry out library bead distribution into picoliter-scale assay reagent droplets, photochemical cleavage of compound from the bead, assay incubation, laser-induced fluorescence-based assay detection, and fluorescence-activated droplet sorting to isolate hits.

Advantageously, when a compound bead is contained within a miniature reaction volume such as a microdroplet, the local concentration of compound within the microdroplet can be much higher than with a single bead contained in a larger scale volume, such as that which can be provided by a microwell plate. Microbeads may have a limited binding capacity for compounds and so by encapsulating them in to smaller volumes this capacity limit may not necessarily translate in to a limited compound concentration for later assays. This is of particular relevance to drug screens, since the container volume then constrains whether a dose exceeds the EC50 of the drug.

Using conventional microfluidic droplet-formation devices it is possible to encapsulate cells and beads and other reagents together in droplets upon formation. Once a droplet is formed within a microfluidic channel, it is technically challenging to add more material in to a droplet. As such most microfluidic devices are constrained in that they must encapsulate all of the target materials in the droplet at the point of initial droplet formation. Thus, the statistics of the encapsulation distribution determines the droplet content, and only a small fraction of droplets may contain all target materials.

A challenge with assaying bead bound DNA-encoded libraries using microdroplets is that, in conventional microdroplet fluidics, small molecules are cleaved from a bead library using UV illumination of droplets as they pass through microfluidic channels. Applying UV illumination in this way to the microdroplets also necessarily illuminates any biological material within the microdroplets, in addition to the beads. This can cause DNA damage and mutations in the biological material which can be detrimental if genetic analysis is required downstream.

Therefore, there is a requirement for an efficient high-throughput screening technique in a droplet microfluidic device which can utilise DELs bound to beads to carry out assays on biological material, without damaging the biological material within the microfluidic device during the illumination phase.

It is against this background that the present invention has arisen.

### SUMMARY OF THE INVENTION

According to an aspect of the present invention, there is provided a method of detecting the interactions between a biological entity and a molecule, the method comprising: providing an array of first microdroplets into a microfluidic chip; wherein each microdroplet contains at least one bead and each bead having a bound photocleavable molecule; providing an array of second microdroplets into the microfluidic chip; wherein each microdroplet contains at least one biological entity; holding the entire first and second arrays of microdroplets; illuminating at least a subset of the first microdroplets containing at least one bead with an illumination source configured to photo-cleave the molecule; subsequently merging at least one subset of the first array of microdroplets with at least one subset of the second microdroplets to form an array of merged microdroplets; and detecting a change in an optical signal from the merged microdroplets using an optical system to indicate the interactions between the biological entity and the molecule.

The method of the present invention enables the selective and localised illumination of at least a subset of first microdroplets with an illumination source configured to photo-cleave molecules from the beads, whilst avoiding the illumination of an array of second microdroplets with the illumination source configured to photo-cleave.

The merging steps or operations as described herein are particularly applicable to the arrays of the microdroplets when utilising EWOD and/or oEWOD techniques. The merge step may comprise microdroplets of mismatched size. For example, it may be necessary to encapsulate the biological entity such as a cell within a larger droplet to facilitate geometrical constraints of the droplet generation process and/or provide a larger nutrient resource for the biological entity. In order to keep the size of the merged droplet as low as possible and enable higher dosing of released compound, the merge may be made with a small microdroplet containing the bead. The merge step may comprise a three-way merge such that the merging microdroplets in one or more of the steps may be mismatched in size. In a further example, a first microdroplet encapsulates a drug loaded bead, a second microdroplet encapsulates a reporter entity, which may be either a cell or a bead, and a third microdroplet encapsulates a cell of interest. These three microdroplets may be merged in whichever order is most appropriate to the work flow. The first merge will result in a larger microdroplet to which a smaller, third microdroplet is then merged. In another example, microdroplets loaded with a stimulant are first merged with microdroplets containing a cell. The merged droplets are then merged with droplets containing the bead.

Microdroplet arrays in flow-cells or chambers, or microdroplets contained within conventional channel-based microfluidics can be used for imaging and sorting of microdroplets. However, it is often difficult and inefficient to carry out the merging step of two or more different arrays of microdroplets in a flow cell, chamber or conventional channel-based microfluidic.

Additionally or alternatively, flow-through microfluidic devices can also be used to cleave molecules from beads in microdroplets. However, flow-through devices only provide a short time period in which to illuminate the microdroplets in order to photocleave the molecule from the bead. Therefore, when using the flow-through microfluidic device, a high power illumination source is often required to cleave the molecule in microdroplets. This may also affect other surrounding microdroplets containing cells that have been exposed to the high power illumination. For example, the high power of the illumination source can damage or kill any cells that are contained within the microdroplets. In particular this damage can include optically-induced mutagenesis. In contrast, the steps of the present invention enable the illumination source to be activated over a longer period of time and at a lower illumination power, in order to cleave the molecules from the bead in the first array of microdroplets without damaging cells in the second array of microdroplets.

According to the present invention, each microdroplet in the array of second microdroplets contains at least one biological entity. Therefore by selectively illuminating only the first microdroplets, damage to the biological entities within the second set of microdroplets by the illumination source configured to photo-cleave can be avoided.

The method of the present invention enables the arrays of first and second microdroplets to be provided to the microfluidic chip prior to the first microdroplets being illuminated with the illumination source configured to photo-cleave. The step of providing the microdroplets to the microfluidic chip can be a time consuming process. Therefore by providing the microdroplets to the microfluidic chip prior to photo-cleaving, the merging step may immediately follow the photo-cleaving step, and the time between photo-cleaving and the merging of first and second microdroplets can be significantly minimised. This is beneficial because it minimises the time which the cleaved molecule spends within the first microdroplet after cleaving from the bead, and minimises the possibility of the cleaved molecule leaking from the microdroplet, thus maximising the time in which the biological entity is in proximity to the photo-cleaved molecule.

In some embodiments, a subset of the first microdroplets may be illuminated with an illumination source configured to photo-cleave. In some embodiments, the entire first array of microdroplets may be illuminated with an illumination source configured to photo-cleave.

In some embodiments, merging the arrays of first and second microdroplets can be done simultaneously, or near simultaneously across the entire microfluidic chip for all droplet pairs. In some embodiments, the merging can take place on a field of view by field of view basis.

In some embodiments, the merging step may also include mixing and/or agitating at least a subset of the first array of microdroplets with at least a subset of the second microdroplets to form an array of merged microdroplets.

In addition, the method of the invention as disclosed herein may comprise multiple merging steps. For example, the first or second array of microdroplets can merge with multiple different arrays of microdroplets, which may contain specific nutrients or minerals, before merging with the second or first array of microdroplets. In another example, the first and second microdroplets can merge together to form an array of merged microdroplets. At any stage, any of the merged or unmerged microdroplets can additionally merge with one or more additional arrays of microdroplets, which may contain other substances such as nutrients, additives or minerals. Such additives may include density modifiers, humectants, desiccants, surfactants or crowding agents. The additional microdroplets may furthermore be used to add reporter entities such as reporter beads, detection reagents, antibodies, stimulants, co-factors, cytokines, substrates, reporter cells, co-stimulating cells, bacteria or viruses. The additional droplets may be merged at any step in the assay, including between the merging of the first and second microdroplets, and prior to the merging of the first and second microdroplets and subsequent to the merging of the first and second microdroplets. Furthermore, it is possible to merge in a fourth, fifth and further set of additional microdroplets at any stage in the assay.

In some embodiments, the holding of the entire first and second arrays of microdroplets may be achieved using an optically mediated force. In some embodiments, the merging of at least one subset of the first array of microdroplets with at least one subset of the second microdroplets may be achieved using an optically mediated force.

In some embodiments, the microfluidic chip may be configured to create an optically mediated force upon illumination of at least a part of the microfluidic chip coupled with the generation of an electric field across the chip. In some embodiments, a single light source may be used for both photo-cleaving and optically mediated control of the microdroplets, by utilising different illumination wavelengths. In some embodiments, two light sources may be used, one optimised to provide the optically mediated force, and the other configured to photo-cleave. In some embodiments, unwanted optically-mediated force from the photocleavage illumination sources may be avoided by modulating the illumination and the electric field generation such that the optically mediated force and the photo-cleaving illumination do not occur simultaneously. In some embodiments the modulation may be achieved by a controller. By modulating the optically mediated force and the photo-cleaving illumination, the arrays of first and second microdroplets can be controlled, whilst preventing interference from the illumination source configured to photo-cleave.

In some embodiments, each bead has a surface upon which a photo-cleavable molecule is located. In some embodiments, illuminating at least a subset of the first microdroplets containing at least one bead with an illumination source configured to photo-cleave the molecule from the surface of the bead.

In some embodiments, the bead material may be polystyrene, TentaGel®, hydrogel, resin or otherwise. In some embodiments, the bead may be magnetic. In some embodiments, the bead may not be magnetic. The bead material can be selected depending on the desired density of cleavable molecules on the surface of the bead. In some embodiments, when the bead is formed from a more porous material such as TentaGel®, the cleavable molecules may be suspended within the bead as well as on the bead surface.

In some embodiments, the cleavable molecule may be a drug molecule, a peptide, a protein, an antibody, or any suitable small molecule.

In some embodiments, the method may include detecting a change in an optical signal from the merged microdroplet. Within the context of the present invention as disclosed herein, it should be understood that the optical signal may originate from any part of the microdroplet. For example, in some embodiments, the optical signal may originate from the merged microdroplet as a whole. In some embodiments, the optical signal may be emitted by the contents of the microdroplet. In some embodiments, the method may comprise detecting a change in an optical signal from the biological entity using an optical system to indicate the interactions between the biological entity and the molecule.

In some embodiments, the method may comprise detecting a change in an optical signal from a reporter, which can be attached to an additional microbead bead. In some embodiments the reporter may be attached to the same bead that bears the photo-cleavable molecule. In some embodiments, the reporter may comprise a plurality of microbeads. In another embodiment the reporter may comprise an additional biological entity of another type. The optical system can detect a change in the optical signal which indicates the interactions between the biological entity and the molecule. The reporter may be, but is not limited to, a protein, peptide, nucleic acid such as DNA, or a fluorescently tagged molecule. The reporter may also be a secreted molecule from the cell or a tagged dye which can change colour upon a change in pH as the biological entity interacts with the molecule. The reporter may be combined with the microdroplet in a subsequent merge operation.

In some embodiments, the biological entity may be a cell or part of a cell or a virus or an enzyme. Additionally or alternatively, the biological entity may be, but is not limited to, an antibody or an antibody fragment thereof; an antigen, a receptor, a ligand, a substrate, a nucleic acid such as DNA, RNA, a part of a cell or an artificial cell, an extracellular vesicle, a liposome, a polymer, a sample of tissue, a bacteriophage, a cytokine and/or a protein.

In some embodiments, the biological entity may be a single cell. In some embodiments, the biological entity may be a multicellular organism such as a fungus or a unicellular organism such as a bacterium. In some embodiments, each of the second microdroplets provided to the microfluidic chip may comprise the same biological entity. In some embodiments the second microdroplets may comprise a set of biological entities which differ from each other through genetic modifications. In some embodiments, each of the second microdroplets provided to the microfluidic chip may comprise a different biological entity. The array of second microdroplets may comprise multiple different cell lines to investigate the interaction between different cell lines and molecules within a single provision of microdroplets to the microfluidic chip.

In some embodiments, the method may further comprise the step of sorting the first and/or second microdroplets on the chip but prior to providing an array of the first and/or second microdroplets into the microfluidic chip. For example, sorting can be used to ensure that the desired number of biological entities or beads are contained within microdroplets that then form the array and can avoid providing empty microdroplets to the array which prevents wasting space on the chip. In some embodiments, microdroplets may be sorted prior to being provided into the microfluidic chip to ensure each microdroplet contains the desired contents. In some embodiments, biological entities and/or reporter entities may be sorted prior to encapsulation in droplets. For example, FACS can be used to select biological entities with particular surface markers prior to encapsulation within microdroplets.

In some embodiments the rows of the second array of microdroplets may be interleaved with the rows of the first array of microdroplets to facilitate minimal distance to move before merging.

In some embodiments, the second microdroplets may each contain a single biological entity. In some embodiments, the second microdroplets may each contain multiple biological entities. It may be desirable to have multiple biological entities, such as cells, within a single microdroplet to overcome issues with heterogeneity between single cells in drug response or expression levels.

In some embodiments, each of the microdroplets within the array of first microdroplets may contain a bead with the same cleavable molecule or plurality of cleavable molecules bound to the bead. It may be advantageous to create multiple microdroplets containing the same bead and cleavable molecule in order to carry out multiple repeats of the same assay. In some embodiments, each of the microdroplets within the array of first microdroplets may contain a bead with a different cleavable molecule or plurality of cleavable molecules bound to the bead or located on the surface of the bead. It may be advantageous to have an array of microdroplets each containing different cleavable molecules to enable the detection of interactions between a biological entity and different molecules within a single provision of microdroplets to the microfluidic chip.

In some embodiments, each of the first microdroplets may contain a single bead. In some embodiments, each of the first microdroplets may contain multiple beads. The multiple beads contained within a single microdroplet may have the same type of cleavable molecules located on the surface of the bead. Alternatively, the multiple beads contained within a single microdroplet may have different cleavable molecules located on the surface of the bead. In some embodiments, multiple beads within the same microdroplet may be used to investigate competitive reactions or interference effects between different molecules and a biological entity.

In some embodiments, positive and/or negative controls can be provided to the microfluidic chip. A positive control can include providing a microdroplet containing a known molecule at a known concentration. A positive control can include providing a microdroplet containing a bead with a photo-cleavable fluorescent or colorimetric dye molecule bound to the bead in order to assess the success of the photo-cleavage event. A negative control can include microdroplets containing beads without cleavable molecules located on the surface of the bead. A negative control can include a bead with inactive cleavable molecules which are known not to have an effect on the biological entities being assayed.

In some embodiments, the method may further comprise the step of sorting the merged microdroplets using the detected optical signal. In some embodiments, the detected optical signal can indicate whether the desired interaction has taken place. In some embodiments, sorting of the microdroplets before merging can ensure each merged microdroplet on the microfluidic chip contains both a bead and a biological cell. In the absence of sorting unmerged microdroplets, the merged microdroplets could be sorted for content in a similar fashion but Poisson statistics would increase the time needed to load a fully populated array of droplets with the desired content. In the absence of a sorting step the proportion of droplets containing a single bead and a single biological cell will be limited by the Poisson-distributed disbursement of entities amongst the droplets. By sorting the droplets to load only those droplets which contain a single entity it is possible to increase the throughput of droplets being assayed which contain the correct materials. Similarly it is advantageous to be able to sort for droplets containing 2, 3 or more entities. This sorting operation can be controlled by means of an optical inspection step whereby the contents of droplets is determined through imaging followed by computational analysis to count the beads or cells contained therein. The sorting process is useful for sorting both beads and cells as well as other items inside the droplets. Alternatively, the sorting process can be used to sort for droplet size. In some embodiments the optical inspection step may include, but is not limited to, bright field, dark field or fluorescence imaging.

In some embodiments, each bead may further comprise a molecular tag on the surface of the bead. In some embodiments, the beads contained within the first set of microdroplets may be provided with a library of cleavable molecules attached to the surface. In some embodiments, the beads contained within the first set of microdroplets may further comprise a molecular tag which can aid in identifying the molecule responsible for an interaction detected during the detection step. In some embodiments, the molecular tag may be a nucleic acid tag, or a protein tag, or a small molecule tag or a synthetic tag. In some embodiments, the molecular tag may be a DNA tag or an RNA tag. In some embodiments, the molecular tag may be an siRNA tag or an mRNA tag. In some embodiments, the molecular tag may be a drug molecule.

In some embodiments, the array of first microdroplets and the array of second microdroplets may be held in an interdigitated array. The interdigitated array enables the first and second microdroplets to be in close proximity to each other. The close proximity of the first and second microdroplets minimises the time between the cleaving of molecules from beads and the merging with microdroplets containing a biological entity. This is advantageous because after the cleaved molecule is released from the surface of the bead, the cleaved molecule is at risk of leaking from the first microdroplet into the surrounding phase. In addition, minimising the time between photo-cleaving the molecule from the bead and the merging step increases the efficiency of the overall method. Furthermore, the close proximity of the first and second microdroplets can minimise the movement between the microdroplets containing cells and the microdroplets containing beads and thus, this reduced movement can lower the risk of the cleaved molecule leaking out of the first microdroplets.

Alternatively, the first and second arrays of microdroplets can be held as two separate arrays.

In some embodiments, an array of further microdroplets may be provided to the microfluidic chip. In some embodiments, each of the further microdroplets may comprise at least one reporter entity. In some embodiments, the reporter entity may be a reporter cell.

In some embodiments, the illumination source may be applied to the first microdroplets for a period of time of between 1 and 300 seconds. In some embodiments, the illumination source may be applied to the first microdroplets for more than 1, 10, 20, 30, 40, 50, 60, 70, 80, 90, 100, 110, 120, 130, 140, 150, 160, 170, 180, 190, 200, 220, 230, 240, 250, 260, 270, 280 or 290 seconds. In some embodiments, the illumination source may be applied to the first microdroplets for less than 300, 290, 280, 270, 260, 250, 240, 230, 220, 210, 200, 190, 180, 170, 160, 150, 140, 130, 120, 110, 100, 90, 80, 70, 60, 50, 40, 30, 20 or 10 seconds. In some embodiments the illumination source may be applied to at least a subset of the first microdroplets for more than 5, 6, 7, 8, 9, 10, 15, 20, 25, 30, 40, 50, 60, 100, 140, 180, 240 minutes.

In some embodiments, the preferred illumination period is dependent on the intensity of the illumination source. For example, if the microdroplets are illuminated with a lower intensity illumination, the illumination source may be required to be applied to the first microdroplets for a longer period of time to provide sufficient energy to photo-cleave the molecule from the bead surface. In some embodiments, the illumination source is applied to the first microdroplets for a preferred time period of between 10 to 60 seconds.

In some embodiments, a longer period of illumination may result in an increased number of cleavable molecules being photo-cleaved from the surface of the bead. By controlling the number of molecules cleaved from the surface of the bead, the concentration of the cleaved molecule that the biological entity is exposed to in the merging step can be controlled. This can facilitate the detection of interactions between biological entities and molecules at different molecule dosages.

Unless otherwise specified, the term ‘dose’ or ‘dosage’ as disclosed in the present invention and within the context of this invention, should be understood to include exposing a biological entity such as a cell to a certain concentration of a molecule such as a drug molecule. In bulk assays a dose response curve may be obtained by treating cells with different concentrations of the same compound. This may facilitate the calculation of the drug concentration achieving a maximum response, Emax, and the drug concentration achieving a half maximal response, EC50.

In order to achieve a tunable dosage, the number of cleavable molecules released from a bead may be varied by varying the time and/or intensity of the photo-cleaving illumination applied to beads contained within the first microdroplets.

A dose response curve may be obtained using the method of the present invention by exposing a single biological entity within a second microdroplet to increasing concentrations of a molecule such as a drug molecule. In some embodiments, this can be achieved by successive merging steps in which a second microdroplet is merged with multiple first microdroplets and successive doses of a cleaved molecule. Furthermore, a dose response curve may be obtained by merging droplets containing samples of the drug molecule with droplets containing a diluent, in order to dilute the drug molecules and so provide a different dose panel.

In some embodiments, the method may further comprise the step of varying the time of the illumination applied to each of the first microdroplets, or in other embodiments, the method may further comprise the step of varying the time of the illumination applied to at least a subset of the first microdroplets. In some embodiments, an array of first microdroplets containing varying numbers of cleaved molecules can be created by varying the time of the illumination applied to each microdroplet whilst maintaining the same illumination intensity. Each of the first microdroplets can therefore contain a different concentration of cleaved molecule, and each first microdroplet may be merged with an identical second microdroplet. This enables the exposure of biological entities to various concentrations of cleaved molecule within a single assay, without requiring successive photo-cleaving steps.

In some embodiments, the illumination source can be applied to one or more of the first microdroplets with a total power of between 0.7 to 400 mW. In some embodiments, the illumination source applied to one or more of the first microdroplets may have a power of more than 0.7, 1, 10, 50, 100, 150, 200, 250, 300 or 350 mW. In some embodiments, the illumination source applied to one or more of the first microdroplets may have a power of less than 400, 350, 300, 250, 200, 150, 100, 50, 10 or 1 mW. In some embodiments, it may be preferable for the illumination source to be applied to one or more of the first microdroplets with a power of between 0.7 to 40 mW. In some embodiments, the illumination source applied to one or more of the first microdroplets may have a power of more than 0.7, 1, 5, 10, 15, 20, 25, 30, or 35 mW. In some embodiments, the illumination source applied to one or more of the first microdroplets may have a power of less than 40, 35, 30, 25, 20, 15, 10, 5 or 1 mW. In some embodiment the illumination source applied to at least a subset of the first microdroplets may have a total power of at least 0.4, 0.5, 0.6, 0.7, 0.8, 0.9, 1.0, 2.0, 3.0, 4.0, 5.0, 10.0 or 100.0 Watts.

In some embodiments, the intensity of the photo-cleaving illumination can be selected depending on the energy required to cleave the bond between the cleavable molecule and the bead. In some embodiments, it may beneficial to use an illumination source with a higher intensity in order to minimise the time taken to cleave a molecule or a plurality of molecules from the surface of the bead. This can maximise the efficiency of the method and minimise the total time of the assay. In some embodiments, it may be beneficial to use an illumination source with a lower intensity for a longer period of time in order to prevent damage to components of the microdroplet medium which may be sensitive to the photo-cleaving illumination.

In some embodiments, the illumination source may be applied to one or more of the first microdroplets at a wavelength of 360 to 380 nm.

In some embodiments, the illumination source applied to one or more of the first microdroplets may have a wavelength of more than 200, 220, 240, 260, 280, 300, 320, 340, 360, 380, 400 or 420 nm. In some embodiments, the illumination source applied to one or more of the first microdroplets may have wavelength of less than 420, 400, 380, 360, 340, 320, 300, 280, 260, 240, 220 or 200 nm. In some embodiments, the preferred wavelength may be 365 nm.

In some embodiments, the illumination source applied to one or more of the first microdroplets may have a wavelength of more than 360, 362, 364, 366, 368, 370, 372, 374, 376 or 378 nm. In some embodiments, the illumination source applied to one or more of the first microdroplets may have wavelength of less than 380, 378, 376, 374, 372, 370, 368, 366, 364 or 362 nm. In some embodiments, the preferred wavelength may be 365 nm.

The illumination source can illuminate the microdroplets at other wavelengths for example, the illumination source may apply to the first microdroplets a wavelength that corresponds to blue light. In some embodiments, the illumination source can be applied at different wavelengths to the one or more first microdroplets, in order to cleave the photocleavable molecule(s) from the bead. Preferably, the illumination source will illuminate the microdroplets at the UV wavelength spectrum to cleave the photocleavable molecule from the bead.

In some embodiments, the method may further comprise the step of varying the intensity of the illumination applied to each of the first microdroplets. In some embodiments, the method may further comprise the step of varying the intensity of the illumination applied to at least a subset of the first microdroplets in a grayscale pattern. In some embodiments, the intensity of the illumination source configured to photo-cleave may be varied such that each of the first microdroplets releases a varying number of molecules from the surface of the bead. This can facilitate the exposure of biological entities to varying concentrations of cleaved molecule within a single assay, without requiring successive photo-cleaving steps.

In some embodiments, varying the time or intensity of the photo-cleaving illumination applied to at least a subset of the first microdroplets can be used to create a concentration gradient of cleaved molecule across at least a subset of the first microdroplets. The concentration gradient can be used to efficiently investigate the effects of variable dosing on biological entities without requiring beads with a varying number of cleavable molecules to be introduced into the device, which can be time consuming and impractical.

In some embodiments, the intensity of illumination for photo-cleaving may be varied and applied across at least a subset of the first microdroplets in a grayscale pattern. The grayscale pattern is formed as the photo-cleaving illumination is applied to at least a subset of the microdroplets for the same amount of time, but with differing illumination intensity across a subset of microdroplets. For example, the illumination applied across a subset of the first microdroplet may be varied from full intensity, to 50% intensity, to 25% intensity. The gradient in the illumination applied across the microdroplets corresponds to a concentration gradient in the number of cleaved molecules within the microdroplets after photo-cleaving has taken place.

In some embodiments, a concentration gradient may be obtained by illuminating microdroplets in at least a subset of the first microdroplets with the same illumination intensity, but for different times across the subset of microdroplets.

In some embodiments, the number of microdroplets which can be illuminated simultaneously depends on the field of view of the optical system configured to apply the illumination for photo-cleaving. The optical system may comprise an objective lens.

In order to tune the energy supplied to the microdroplets for photocleaving, the power applied and/or the duration of the illumination of the microdroplets may be varied. This enables photocleaving to take place efficiently but without the use of such high power illumination that the contents of the microdroplets are damaged.

In some embodiments, it may be advantageous to maximise the number of microdroplets which are illuminated simultaneously in order to parallelise the method thereby saving time and maximising the efficiency of the method.

In some embodiments, the method may further comprise the step of varying the intensity or time of the illumination used for holding the microdroplets in an array, and this illumination can be applied to at least a subset of the first and/or second microdroplets in a grayscale pattern. In some embodiments, in which the microdroplets are held and manipulated with an optically mediated force, it may be possible to vary the intensity of the controlling illumination source applied to each microdroplet or a subset of the first and/or second microdroplets. In some embodiments, it may be advantageous for the microdroplets to be held and/or controlled by a weaker force in certain areas of the microfluidic chip. For example, it may be advantageous for the microdroplets to be under a weaker optically mediated control as they are provided into the microfluidic chip, to facilitate the efficiency with which they can be formed into an array. In subsequent stages of the assay, it may be beneficial to hold and/or control the microdroplets with a stronger force. In some embodiments, the controlling light source may be used at a lower illumination intensity, for example 80% of the illumination intensity, in the area of the chip where the microdroplets are initially provided. The illumination intensity of the controlling light source may be 100% in other areas of the chip in which a stronger holding force is required.

In some embodiments, the method may further comprise the step of splitting at least a subset of the arrays of the first and/or second microdroplets. In some embodiments, after the initial illumination of a first microdroplet with the illumination source configured to photo-cleave, the first microdroplet may be split prior to the merging step. In some embodiments, the first microdroplet may be split such that the cleaved molecule is contained within a portion of the microdroplet, and the cleaved molecule with the bead is contained within another portion of the microdroplet.

In some embodiments, media may be added into the microfluidic chip. In some embodiments, after splitting, the volume of the split microdroplets may be increased by adding media to the microfluidic chip and merging the split microdroplets with the media. The microdroplet containing the cleaved molecules after the splitting step may be merged with a microdroplet containing a biological entity. In some embodiments, the microdroplet containing the bead after the splitting step may be used in subsequent photo-cleaving steps. When microdroplets are split in to portions using optical electrowetting, it is possible to retain information encoding the identity of the progenitor droplet containing the bead, and subsequently link the progenitor bead identity to the outcome of assays conducted using the split droplet. Subsequently, progenitor beads can be selected for further assaying or recovery on the basis of the assay results.

In some embodiments, it may be possible to expose the same bead to successive periods of photo-cleaving illumination, in order to release further cleavable molecules from the bead surface. Successive illuminations with the same photo-cleaving illumination will release exponentially less molecules from the bead each time. Therefore a higher subsequent illumination time and/or intensity may be required to release the same amount of molecules from the bead in a subsequent step and achieve the same dosing level. It may be advantageous to photo-cleave molecules from the same bead in successive steps to increase the efficiency of space used on the microfluidic chip and minimise the number of beads required to achieve the desired dosing of the biological entities.

In some embodiments, the detection of a change in the optical signal from the merged microdroplets exceeding a pre-determined threshold level may be further configured to determine the concentration of molecules or the number of molecules released from the bead.

In some embodiments, the optical signal from the merged microdroplet may be a fluorescence signal which may indicate a positive response when a pre-determined threshold for fluorescence is exceeded. The fluorescence signal may be compared to model systems in order to determine the concentration of molecules or number of molecules released from the bead.

In some embodiments, the optical signal may be a fluorescence signal or it may be a Fluorescence Resonance Energy Transfer (FRET) signal or it may be a Homogenous Time Resolved Fluorescence (HTRF) signal or a luminescence signal, or a chemiluminescent signal.

In some embodiments, the optical signal can be detected via a fluorescence assay on the bead or cell, a luminescence assay on the bead or cell, a brightfield or darkfield image of cell morphology or number. Positive hits may be dark or bright or indicate a change in cell morphology or proliferation. The outcome of the assay may be a binary outcome, or it could be a quantifiable event in response. This could be the measured response of a cell to the released small molecule which may indicate the effectiveness of a drug. Alternatively, a labelled antibody and/or catch reagent could be released to take part in an ELISA-style sandwich assay for e.g. cytokine detection. In some embodiments, a HTRF signal may be advantageous as it can have a reduced background compared to other types of signal. In some embodiments, a HTRF signal can have an improved signal to noise ratio.

Intracellular imaging may also be deployed and can reveal signal within part of a cell or cell container, examples include the nucleus, Golgi apparatus and/or mitochondria.

In some embodiments, the array of first microdroplets may be provided to the microfluidic chip before the array of second microdroplets.

In some embodiments, the method may further comprise the step of introducing the array of second microdroplets and the array of first microdroplets sequentially into the microfluidic chip. In some embodiments, cell-containing droplets may be loaded before bead containing droplets or vice versa.

In some embodiments, the method may further comprise the step of introducing the first and second arrays of microdroplets simultaneously into the microfluidic chip.

The first and second arrays of microdroplets may be loaded at the same time through different inlets. Simultaneous loading of first and second microdroplets into the microfluidic chip can minimise the loading time and increase the device throughput.

In some embodiments, the microdroplets may contain a cell media. In some embodiments, the cell media may include EMEM, DMEM, RPMI, F-12. In some embodiments, the microdroplets may contain modified cell media. For example, the cell media may contain added antibiotics, buffers including pH buffer and or conditioned media. In some embodiments, the microdroplets may include density modifiers such as, but not limited to, Optiprep.

Additionally or alternatively, the microdroplets may contain, but is not limited to, an additive for example, supplements, density modifiers, agonist molecules, antagonists, humectants, dessicants, co-factors, stimulants, cytokines, suppressants or crowding agents.

In some embodiments, the method may further comprise the step of supplying a carrier fluid into the microfluidic chip. The carrier fluid can be an oil. In some embodiments, surfactant exchange may be carried out to reduce surfactant levels by exchanging the oil. In some embodiments, the device may be pre-primed with low surfactant oil compared to the oil used for the loaded microdroplet emulsion. Lower concentrations of surfactants within the carrier fluid can help reduce the leakage of the photocleaved molecules in to the carrier fluid surrounding the microdroplets. In some embodiments, the oil may be conditioned with cell media to improve cell viability. In some embodiments, the oil may be enriched with dissolved oxygen and/or carbon dioxide to replenish the supply of gas to the microdroplets containing cells, and extend cell viability in the device.

In some embodiments, the array of first microdroplets and/or the array of second microdroplets may comprise microdroplets of different sizes. In some embodiments, the array of first microdroplets and/or the array of second microdroplets may comprise droplets with a diameter of 5 to 200 μm.

The diameter of the first and/or second microdroplets may be more than 5, 10, 20, 30, 40, 50, 60, 70, 80, 90, 100, 110, 120, 130, 140, 150, 160, 170, 180 or 190 μm. In some embodiments, the diameter of the first and/or second microdroplets may be less than 200, 190, 180, 170, 160, 150, 140, 130, 120, 110, 100, 90, 80, 70, 60, 50, 40, 30, 20 or 10 μm.

The size of a microdroplet may be utilised to vary the concentration of the cleaved molecule to which the biological entity is exposed in the merging step. Smaller microdroplets may be used to expose biological entities to a higher concentration of cleaved molecule. The minimum microdroplet size is dependent on the minimum volume of cell media required within a microdroplet to maintain the viability of a biological entity throughout the assay period. A maximum microdroplet size may be dependent on the useful concentration of cleavable molecule.

In some embodiments, microdroplets of multiple different sizes may be used to form the first and/or second array. In some embodiments, microdroplets may increase in volume after merging and therefore may increase in size during the assay.

In some embodiments, microdroplets may be provided into the microfluidic chip with a greater efficiency by utilising smaller microdroplets. Smaller microdroplets may also require less space on the microfluidic chip. When using smaller microdroplets it may be necessary to increase the number of biological entities used to form the microdroplets. This may be necessary to avoid having a large number of empty microdroplets within the microfluidic chip, which can be time consuming to sort and remove from the chip, and decrease the efficiency of the assay.

In some embodiments, the array of first microdroplets and/or the array of second microdroplets may comprise microdroplets of substantially the same size.

In some embodiments, the method may further comprise the step of dispensing microdroplets into a receptacle such as a well plate. In some embodiments, beads and/or cells corresponding to positive hits can be recovered via dispense into a well plate. The well plate can contain a buffer, or aqueous solution, or DNA stabilising solution. This solution may also include suitable primers for sequencing. Droplets in emulsion can be ruptured in the well plate leaving a bead in aqueous solution. Alternatively beads can be dispensed into oil and allowed to substantively dry before adding an aqueous solution.

Beads can be dispensed into individual wells in a well plate to retain phenotypical information linked to the biological entity, or beads can be pooled together for dispense, in which case multiple beads are dispensed into a single well in a well plate.

In some embodiments, one or more droplets can be selected for recovery on the basis of an optical measurement.

In some embodiments, the optical measurement is conducted on a droplet which has been split from a progenitor droplet and the progenitor droplet is accordingly selected for recovery.

According to a further aspect of the present invention, there is provided an apparatus for detecting the interaction between a biological entity and a molecule, the apparatus comprising: a microfluidic chip comprising a microfluidic space and an inlet for introducing an array of first microdroplets and an array of second microdroplets into the microfluidic space; wherein each of the first microdroplets contain at least one bead and each bead having a bound photocleavable molecule; wherein each of the second microdroplets contain at least one biological entity; wherein the first and second arrays of microdroplets merge to form an array of merged microdroplets in the microfluidic space; an illumination source for illuminating at least a subset of the first microdroplets containing at least one bead in the microfluidic space; wherein the illumination source is further configured to photo-cleave the molecule; a controller configured to control the time or intensity or wavelength of the illumination source being applied to the first microdroplets; an optical system configured to detect a change in an optical signal from the merged microdroplets to indicate the interactions between the biological entity and the molecule; and a dispense system configured to eject droplets from within the microfluidic space into a receptacle.

In some embodiments, the microfluidic device may be an opto-electrowetting on dielectric (oEWOD) device, or an electrowetting on dielectric (EWOD) device, or a dielectrophoresis (DEP) device.

In some embodiments, the illumination source may be an ultra-violet illumination source. In some embodiments, the illumination source configured to photo-cleave the molecule from the surface of the bead may be a blue light source or may be a white light source. In some embodiments, the illumination source configured to photo-cleave the molecule from the surface of the bead may be any illumination source capable of achieving a sufficient energy to photo-cleave the molecule from the surface of the bead.

In some embodiments, the apparatus may further comprise a Homogeneous Time Resolved Fluorescence (HTRF) reader.

In some embodiments, the environment surrounding the microdroplets can be controlled. For example, the temperature of the microdroplets may be maintained at 37° C. by passing current through the microfluidic chip. In some embodiments, a microdroplet emulsion may be cooled off chip. In some embodiments, the biological entities contained within the array of second microdroplets may be chilled prior to being provided to the microfluidic chip. In some embodiments, there may be a recovery period prior to detecting an optical change to enable the biological entities to recover. In some embodiments, the microfluidic chip may comprise a Peltier system which facilitates cooling of the microdroplets whilst they are within the microfluidic chip. In some embodiments, microdroplets may be cooled to between 20° C. and 25° C. Cooling the microdroplets may slow down the consumption of nutrients by biological entities contained within microdroplets. Cooling the microdroplets may slow down the secretion rate and production of waste produced by biological entities contained within the microdroplets. Slowing down the consumption of nutrients and/or the production of waste may prolong the viability of biological entities within the microfluidic chip.

According to another aspect of the present invention, there is provided a cartridge comprising: a reservoir containing a liquid sample; an emulsifier in a fluidic circuit with the reservoir, the emulsifier is configured to generate a medium comprised of an emulsion of aqueous microdroplets in an immiscible carrier fluid; an inlet channel provided downstream of the emulsifier, wherein the inlet channel is configured to receive the medium comprised of the emulsion of aqueous microdroplets in the immiscible carrier fluid from the emulsifier; a device according to any one of the aspects of the present invention, whereby the device comprises at least an inlet port and the device is in fluid communication with the inlet channel; and a pumping system provided to induce the flow of the liquid sample to the emulsifier and/or induce the flow of the medium comprised of the emulsion of aqueous microdroplets in the immiscible carrier fluid through the device.

Suitably, the aqueous fluids within the cartridge may be biological fluids such as cell media, and they may contain cells, beads, particles, drugs, biomolecules or other biological entities. These entities may be viruses, DNA or RNA molecules, stimulants, cytokines, nutrients and dissolved gases. As such the design of the cartridge channels and structures may be optimised such that the dispersion and integrity of the biological fluids is preserved, particularly by selection of well-matched channels of even hydraulic diameter and minimal fluid shear.

In some embodiments, the cartridge may further comprise one or more valves provided at the inlet port of the device, wherein the valve controls the flow of the medium, comprised of the emulsion of aqueous microdroplets in the immiscible carrier fluid, through the device.

In some embodiments, the emulsifier may be a step emulsifier. In some embodiments, several emulsifiers may be provided, each of which is provided with an inlet channel.

In some embodiments, the pumping system can include, but is not limited to, a pump, a head reservoir, an accumulator and/or a pressure source. It will be further appreciated that the skilled person in the art would know other pumping system that could be used to induce the flow of the liquid sample to the emulsifier and/or induce the flow of the medium through the device.

A number of technologies are known in the art for the formation of aqueous emulsions of microdroplets surrounded by an immiscible carrier phase. These include cross-flow emulsion generators, T-junction generators and step emulsification devices. Cross-flow emulsion generators, T-junction emulsion generators and other related devices are typically used to make microdroplets of variable sizes. The size distribution of the microdroplets is dependent on the flow conditions created at the junction where oil and aqueous material intersect. Furthermore, the microdroplet size is dependent on the fluid properties, such as the interfacial tensions and viscosities of the running fluids. As such, it is necessary to precisely control and adjust the flow rate of the fluids entering these types of emulsion generators in order to provide a uniform and repeatable size distribution of droplets into the oEWOD device.

Advantageously, a step emulsifier generates emulsion with a microdroplet size distribution that has a minimal dependency on the flow velocities at the emulsification junction. The size of the microdroplets is determined predominantly by the physical dimensions of the emulsification nozzle, as well as the material properties of the running fluids. Whilst both step emulsifiers and other emulsifiers are sensitive to the properties of the running fluids, the degree of dependency on interfacial tension and viscosity is considerably reduced in a step emulsifier device. As such, it is not necessary to precisely control and adjust flow parameters in order to correct the microdroplet size distribution emitting from the emulsifier. It can be operated with a simple fixed-flow-rate or fixed-pressure system. It is particularly suitable for operation with an oEWOD device because it avoids the requirement for inspection and optical access to an emulsifier device in a location, which might otherwise overlap with the optical assembly used for operation of the OEWOD device. It avoids the complexity and cost of introducing a plurality of inspection and microdroplet size monitoring devices in order to monitor and control a plurality of emulsifiers being operated within one cartridge assembly. Therefore, a number of independent step emulsifiers can be connected to different inlets on the oEWOD device to provide fluidically isolated emulsion-generating input paths between the aqueous input and the oEWOD device. The use of fluidically-isolated input paths allows for the oEWOD device to receive a set of independent emulsion inputs formed from different aqueous input materials without the possibility of cross-contamination between them.

In some embodiments, the cartridge assembly may contain up to eight emulsifiers. In some embodiments, the cartridge assembly may contain at least 1, 2, 3, 4, 5, 6 or 7 emulsifiers. In some embodiments, the cartridge assembly may contain between 8 and 12 emulsifiers. In some embodiments, the cartridge assembly may contain between 12 to 20, 20 to 30, 30 to 50 or 50 to 100 emulsifiers.

The emulsifiers may be interchangeable by the user such that the user can choose a suitable type of emulsifier for their intended purposes. For example, the user may configure a cartridge with emulsifiers that provide a particular microdroplet size range. The user may choose a set of emulsifiers each providing microdroplets with a different size range, or a sub-selection of size ranges. In some embodiments, the emulsifiers may be configured to generate microdroplets of volumes in the range 14 μL to 180 μL, or microdroplets in the range 180 μL to 500 μL, or in the range 500 μL to 1.2 nL. The emulsifiers may also be configured to provide microdroplets of volume less than 14 μL, particularly in the size range 10 fL to 50 fL or between 50 fL and 14 μL. In some embodiments, the emulsifiers may be configured to generate microdroplets of more than 1.2 nL, including at least the ranges of 1.2 nL to 4 nL. In the case where the emulsifiers are step emulsifiers, it is possible to alter the volume of the microdroplets by changing the geometry of the emulsification nozzle, particularly changing the height of the nozzle in the minor axis of the rectangular nozzle.

Furthermore, it is possible to parallelise the operation of a set of step emulsifier nozzles within a single emulsifier device, so that multiple emulsification nozzles are connected to a single aqueous input. The connected nozzles can run independently with variation in speeds determined by the complex interplay between the interconnected junctions. The emulsifiers can all generate microdroplets of substantially uniform size determined by the physical size of the nozzles. This allows for a large number of generators running in parallel at low flow velocities, eliminating the deleterious effects of shear that can damage cells and other biological materials. It also allows the emulsifier to continue generating emulsion despite the partial occlusion or blocking of some nozzles that is the occasional consequence of running biological material comprising particulates through narrow nozzle apertures.

According to an aspect of the present invention, there is provided a species screened by the device, apparatus, cartridge or method as disclosed herein.

According to an aspect of the present invention, there is provided a species selected by the device, apparatus, cartridge or method as disclosed herein.

According to an aspect of the present invention, there is provided a species isolated by the device, apparatus, cartridge or method as disclosed herein.

According to an aspect of the present invention, there is provided a species made by the device, apparatus, cartridge or method as disclosed herein.

The species may be chemical, biochemical, or biological in nature.

For example, the present invention may provide an agonist/antagonist to an entity as identified by the screening, selection and/or isolation method disclosed herein. The present invention may provide an agonist/antagonist to an entity as identified by the screening, selection and/or isolation method disclosed herein, for use in therapy. The entity may be chemical, biochemical, or biological in nature.

According to an aspect of the present invention, there is provided a use of the device, apparatus, cartridge, method or species as disclosed herein.

According to an aspect of the present invention, there is provided a use of the device, apparatus, cartridge, method or species as disclosed herein in therapy.

The present invention may provide for a use of the device, apparatus, cartridge, method or species as disclosed herein in making a product. The product made may be chemical, biochemical, or biological in nature.

The use may be peptide synthesis. The use may be synthetic biology. The use may be cell line engineering or development. The use may be cell therapy. The use may be drug discovery. The use may be antibody discovery.

According to an aspect of the present invention, there is provided a use of the device, apparatus, cartridge, method or species as disclosed herein in analysis.

The analysis may be physical, chemical, or biological.

The use may be sub-cellular imaging. The use may be high content imaging.

The use may be diagnostics.

The use may be a biological assay. The biological assay may be high throughput screening. The biological assay may be ELISA.

The use may be cell secretion.

The use may be QC safety profiling.

### FIGURES

The invention will now be further and more particularly described, by way of example only, and with reference to the accompanying drawings, in which:

FIG. 1 shows, schematically, the photo-cleaving of molecules bound to a bead surface within a microdroplet;

FIG. 2 shows, schematically, merging the microdroplet containing the photo-cleaved molecules with a microdroplet containing a biological entity, to produce a merged microdroplet;

FIGS. 3A and 3B provide an array of light sprites capable of holding droplets in an array and a photocleaving illumination pattern;

FIG. 4A illustrates various droplets being sorted into rows containing cells and single beads;

FIG. 4B illustrates the merging operations of droplets;

FIGS. 5A and 5B show an array of droplets sorted into alternating columns of droplets containing cells and droplets containing single beads; and

FIG. 6 provides an array of light sprites with varied intensity per column.

### DETAILED DESCRIPTION

The present invention herein discloses a method and apparatus for detecting the interactions between a biological entity 24 and a molecule 16. Arrays of first microdroplets 12 and second microdroplets 22 are provided into a microfluidic chip, and the entire first and second arrays of microdroplets are held in the microfluidic chip. Microdroplets may be sorted prior to being provided into the microfluidic chip, such that only microdroplets with desired contents are provided to the microfluidic chip.

Referring to FIG. 1, there is shown a first microdroplet 12 containing a bead 14, the bead 14 comprising a surface on which a plurality of cleavable molecules 16 are located. The bead 14 material may be polystyrene, TentaGel®, hydrogel, resin or otherwise. When the bead 14 is a polystyrene material, the cleavable molecules 16 may be located on the surface of the bead 14. When the bead is a more porous material, for example TentaGel®, the cleavable molecules 16 may also be suspended within the bead 14. The bead 14 may or may not be magnetic. The bead 14 material can be selected depending on the desired density of cleavable molecules 16 on the surface of the bead 14. A first microdroplet 12 may contain a plurality of beads 14. The cleavable molecules 16 may be a drug molecule, a protein or peptide, an antibody, or any suitable small molecules. Additionally, the surface of the bead 14 comprises one or more DNA tags 18, which can aid in the identification of the cleavable molecule 16 responsible for an interaction at a later stage of the assay. The microdroplets contain a fluid 20. The fluid 20 may include, but is not limited to, one or more of the following; a surfactant, a cell media such as EMEM or DMEM or RPMI or F-12, antibiotics, a buffer solution, conditioned media and/or a density modifier.

As shown in FIG. 1, within the microfluidic chip, an illumination source can be applied to the first microdroplet 12, such that that the cleavable molecule 16 is photo-cleaved from the surface of the bead 14. The illumination source may be an ultra-violet illumination source, a blue light source, a white light source, or any other source of illumination capable of achieving a sufficient energy to break the bond between the linkers attaching the cleavable molecules 16 to the surface of the bead 14. The DNA-tags 18 attached to the bead 14 are not cleaved by the illumination, and are retained on the bead 14. The beads 14 with attached DNA tags 18 can be dispensed off the microfluidic chip in a subsequent step and read out to identify which cleavable molecule 16 was originally attached to the bead 14.

As shown in FIG. 1, all of the molecules 16 can be cleaved from the surface of the bead 14. Alternatively, the illumination time and/or intensity may be adjusted such that only some of the molecules 16 are cleaved from the surface of the bead 14. Sequential photo-cleaving steps can be performed to increase the concentration of the cleaved molecule 16 within the first microdroplet 12. The first microdroplet 12 may be split such that the cleaved molecule 16 is contained within a portion of the microdroplet, and the bead 14 is contained within another portion of the microdroplet. The volume of the split microdroplets may be increased through the addition of media to the microfluidic chip and merging the split microdroplets with the media. The microdroplet containing the cleaved molecules 16 after the splitting step may be merged with a second microdroplet 22. The microdroplet containing the bead 14 after the splitting step may be used in subsequent photo-cleaving steps if the bead 14 has remaining molecules 16 attached to its surface.

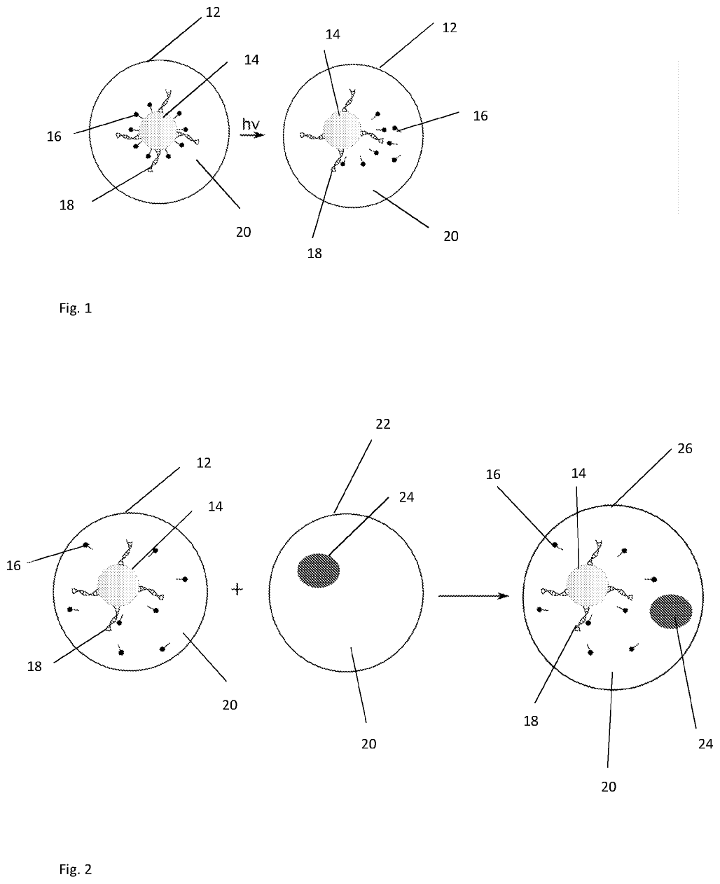

Referring to FIG. 2, a first microdroplet 12 containing cleaved molecules 16 may be merged with a second microdroplet 22 containing at least one biological entity 24 to form a merged microdroplet 26. An array of first microdroplets 12 may be merged with an array of second microdroplets 22 simultaneously, or near simultaneously across the entire microfluidic chip, or on a field of view by field of view basis. Merging the first microdroplet 12 and the second microdroplet 22 may include mixing and/or agitating to form a merged microdroplet 26. The composition of fluid 20 in the first and second microdroplets may be the same or it may be of differing composition.

The biological entity 24 may be a cell, virus, protein sample, an antibody sample, a functionalised microbead or an enzyme. The second microdroplet 22 is not exposed to the photo-cleaving illumination, and as such the biological entity 24 is protected from DNA damage and mutations which can be detrimental if genetic analysis is required downstream. During the merging step, the biological entity 24 is exposed to the cleaved molecule 16 within the first microdroplet 12. The concentration of cleaved molecule 16 to which the biological entity 24 is exposed, is dependent on the amount of molecules 16 released from the bead 14 during the photo-cleaving step, as shown in FIG. 1.

It is advantageous to minimise the time between the photo-cleaving step, shown in FIG. 1, and the merging step, as shown in FIG. 2. Once the cleaved molecules 16 are released into the fluid 20 of the first microdroplets 12, there is potential for the cleaved molecules 16 to leak out of the first microdroplet 12 and into the surrounding phase. In order to minimise the time between photo-cleaving and merging steps, the first microdroplets 12 and second microdroplets 22 may both be provided to the microfluidic chip prior to the photo-cleaving step. The photo-cleaving step, as shown in FIG. 1, can be carried out in a selective and localised manner, such that the second microdroplets 22 are not illuminated by the photo-cleaving illumination whilst the first microdroplets 12 are illuminated. In some embodiments, the arrays of first microdroplets 12 and second microdroplets 22 may be arranged in an interdigitated array to minimise the time between the photo-cleaving and merging steps.

The photo-cleaving step as shown in FIG. 1 may be carried out on an array of first microdroplets 12 with varying intensity and/or length of photo-cleaving illumination. It is possible to produce an array of first microdroplets 12 with different concentrations of cleaved molecule 16 within the first microdroplets 12 across the array. During the merging step, an array of identical second microdroplets 22 can be merged with the array of first microdroplets 12 to expose the biological entities 24 within the second microdroplets 22 to varying doses of the cleaved molecule 16. This enables the effect of dosage to be investigated without having to prepare beads 14 with a varying number of cleavable molecules 16 attached to the surface, and the effect can be investigated within a single provision of microdroplets into the microfluidic chip.

Alternatively or additionally, a merged microdroplet 26 may undergo successive merging steps with a plurality of first microdroplets 12, such that a biological entity 24 is exposed to successive doses of a cleaved molecule 16.

A change in an optical signal may be detected from the merged microdroplets 26 using an optical system to indicate the interactions between the biological entity 24 and the cleaved molecule 16. The detected optical signal may be emitted from the merged microdroplet 26 as a whole, or may be emitted by the contents within the merged microdroplet 26. Merged microdroplets 26 may be sorted using the detected optical signal.

The optical signal may be, but is not limited to, a fluorescence signal, or a FRET signal, or a HTRF signal. The optical signal may be detected by a fluorescence assay on the bead 14 or biological entity 24, a luminescence assay on the bead 14 or biological entity 24, a brightfield or darkfield image of the biological entity 24 morphology or number. A luminescence assay on the bead 14 or biological entity 24 may be used in conjunction with a reporter system. For example the microdroplets 12, 22 may contain one or more binding partners which are brought together when the microdroplets are merged. The binding partners may be, for example, a capture component such as an antibody and/or a biological entity 24. One or more binding partners may be brought together to provide a molecular entity or system with functional activity. For example, parts of an enzyme can be brought together and bind together to form a whole enzyme with functional activity. The enzyme may then create a luminescence signal when a substrate is present to produce a catalytic reaction. The luminescence signal generated by the enzyme reaction can then be detected by a luminescence assay.

Luminescence assays can be, but is not limited to, one or more of the following techniques: chemiluminescence; ECL (enhanced chemiluminescence); Bioluminescence; Bioluminescence resonance energy transfer (BRET); Flash luminescence and Glow luminescence.

Additionally or alternatively, the optical signal from the merged microdroplet 26 may be a fluorescence signal which may indicate a positive response when a pre-determined threshold for fluorescence is exceeded. The fluorescence signal may be compared to model systems in order to determine the concentration of cleaved molecules 16 or number of cleaved molecules 16 released from the bead 14.

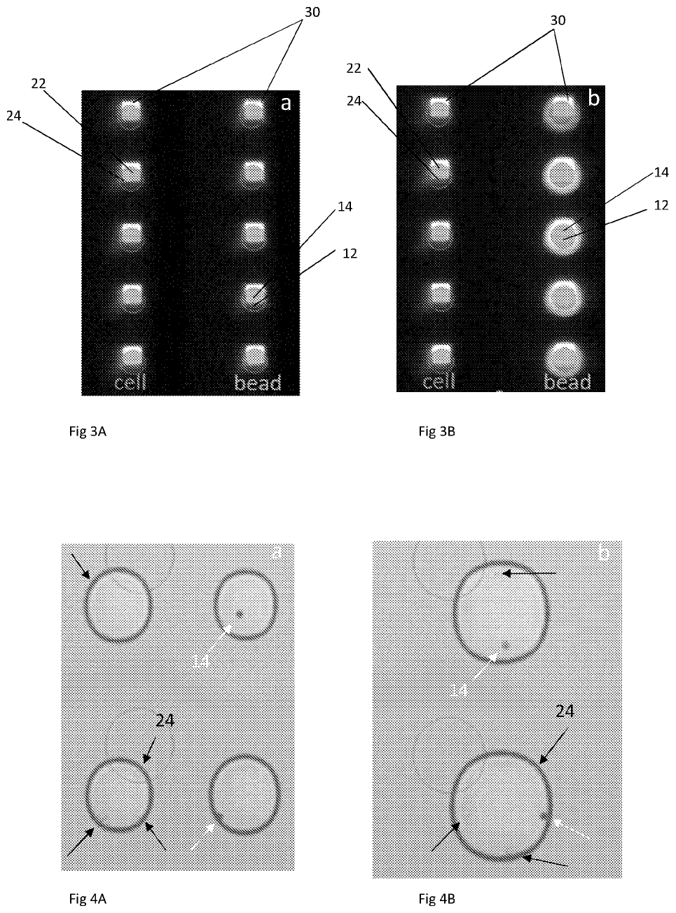

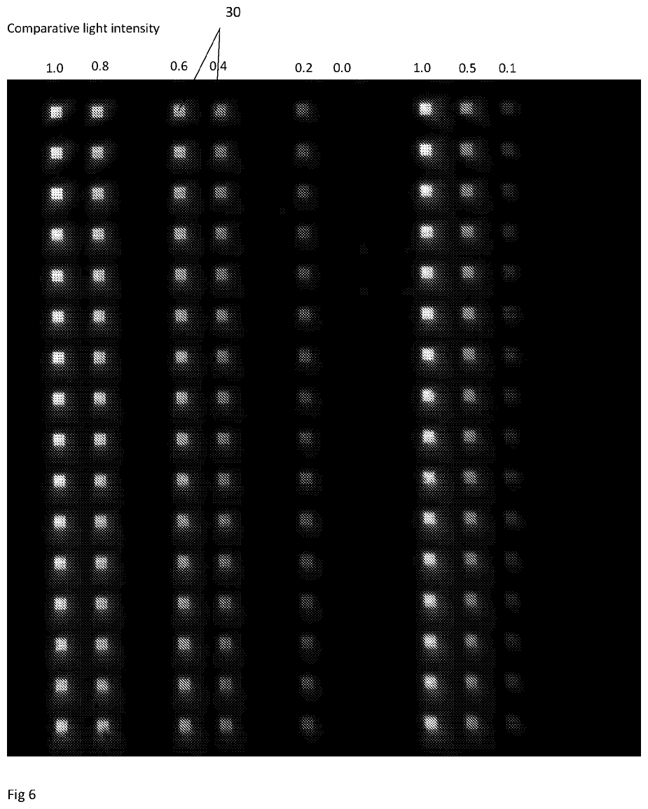

Referring to FIGS. 3A and 3B, there is shown a plurality of light sprites 30 capable of holding droplets in an array. As shown in FIGS. 3A and 6B, the light sprites 30 are indicated as a square, but the skilled person would understand that light sprites 30 can take any form, shape or configuration. FIG. 3A illustrates the holding locations for microdroplets, paired in rows with columns designated for those containing cells 24 and those containing beads loaded with a photocleavable compounds. Referring to FIG. 3B, a photocleaving illumination spot, which can be UV light, can then be applied selectively to the spaces designated for microdroplets containing beads and not to the designated spaces for microdroplets containing cells.

Referring to FIG. 4A, there is provided a plurality of microdroplets 12, 22 being sorted into rows containing one or more cells 24 and single beads 14. In other examples, not illustrated in the accompanying drawings, the microdroplets 22 containing the cells may be selected specifically during the load to ensure that they all have single cells 24 contained therein.

In the example shown in FIG. 4A microdroplets 22 containing cells and microdroplets 12 containing beads 14 are held in separate arrays. An illumination source, such as UV light, can then be applied to the subset of microdroplets 14 containing beads 14 to trigger the release of a photocleavable compounds from the beads 14. As shown in FIG. 4B, the microdroplets 22 containing cells 24 and the microdroplets 12 containing beads 14 are moved together and merged to introduce photocleaved compounds released from the beads 14 to the cells 24.

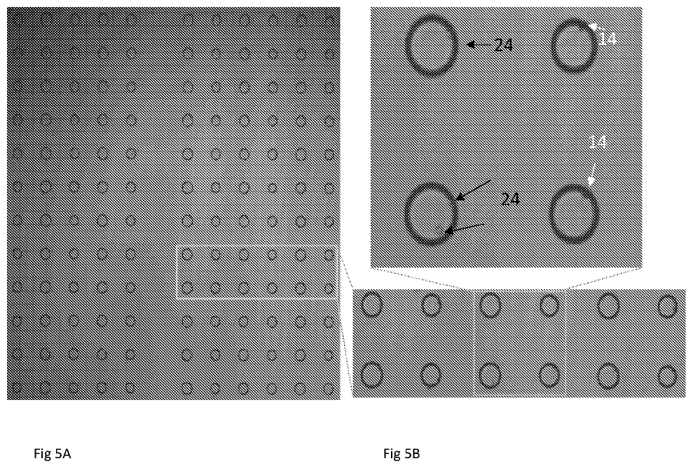

Referring to FIG. 5A, there is shown an array of microdroplets 22, 12 being sorted into alternating columns of droplets containing cells 24 and droplets containing single beads 14. FIG. 5B shows a portion of the array as shown in FIG. 5A. In FIG. 5B, microdroplets 22, 12 are being selected and matched together in pairs before the merging operation.

Referring to FIG. 6, there is shown an array of photocleaving illumination spots 30 with varied intensity per row. When photocleaving illumination is applied to the microdroplets 12 containing beads 14, the gradient in intensity of the photocleaving spots 30 results in a gradient in the concentration of released drug from the bead 14 by photocleavage. Intensity of photocleaving spots 30 can be varied arbitrarily or on a repetitive cadence as desired. Examples of two arrays with different intensity steps between rows are shown within the same microfluidic chip.

By way of example only, if the microdroplets are illuminated with a lower intensity illumination, the illumination source may be required to be applied to the first microdroplets for a longer period of time to provide sufficient energy to photo-cleave the molecule from the bead surface.

In another example, a longer period of illumination may result in an increased number of cleavable molecules being photo-cleaved from the surface of the bead. By controlling the number of molecules cleaved from the surface of the bead, the concentration of the cleaved molecule that the biological entity is exposed to in the merging step can be controlled. This can facilitate the detection of interactions between biological entities and molecules at different molecule dosages.

Varying the time or intensity of the photo-cleaving illumination applied to at least a subset of the first microdroplets can be used to create a concentration gradient of cleaved molecule across at least a subset of the first microdroplets. A higher intensity being applied to at least a subset of the first microdroplets results in a higher concentration of cleaved molecules. The concentration gradient can be used to efficiently investigate the effects of variable dosing on cells without requiring beads with a varying number of cleavable molecules to be introduced into the device. In some cases, it may be advantageous to vary the intensity of the illumination and/or vary the time on which the illumination is applied to at least a subset of the first microdroplets to control photocleaving of molecules on the bead(s).

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments, it is not limited to the disclosed embodiments and that alternative embodiments could be constructed without departing from the scope of the invention as defined in the appended claims.

1-34. (canceled)

35. A method of detecting the interactions between a biological entity and a molecule, the method comprising
providing an array of first microdroplets into a microfluidic chip; wherein each microdroplet contains at least one bead and each bead having a bound photocleavable molecule;
providing an array of second microdroplets into the microfluidic chip; wherein each microdroplet contains at least one biological entity;
holding the entire first and second arrays of microdroplets;
illuminating at least a subset of the first microdroplets containing at least one bead with an illumination source configured to photo-cleave the molecule;
subsequently merging at least one subset of the first array of microdroplets with at least one subset of the second microdroplets to form an array of merged microdroplets; and
detecting a change in an optical signal from the merged microdroplets using an optical system to indicate the interactions between the biological entity and the molecule.

36. The method according to claim 35, wherein the biological entity is a cell or part of a cell or a virus or an enzyme.

37. The method according to claim 35, further comprising the step of sorting the first and/or second microdroplets prior to providing an array of the first and/or second microdroplets into the microfluidic chip.

38. The method according to claim 35, further comprising the step of sorting the merged microdroplets using the detected optical signal.

39. The method according to claim 35, wherein each bead further comprises a molecular tag on the surface of the bead, wherein the molecular tag is a nucleic acid tag, or a protein tag, or a small molecule tag, or a synthetic tag.

40. The method according to claim 35, wherein the array of first microdroplets and the array of second microdroplets are held in an interdigitated array.

41. The method according to claim 35, wherein an array of further microdroplets is provided to the microfluidic chip, wherein each of the further microdroplets comprises at least one reporter entity.

42. The method according to claim 35, wherein the illumination source is applied to the first microdroplets for a period of time of between 1 and 300 seconds.

43. The method according to claim 35, further comprising the step of varying the time of the illumination applied to at least a subset of the first microdroplets.

44. The method according to claim 35, wherein the illumination source is applied to one or more of the first microdroplets with an intensity of between 0.7 to 400 mW.

45. The method according to claim 35, wherein the illumination source is applied to one or more of the first microdroplets at a wavelength of 360 to 380 nm.

46. The method according to claim 35, further comprising the step of varying the intensity of the illumination applied to at least a subset of the first microdroplets in a grayscale pattern.

47. The method according to claim 35, further comprising the step of splitting at least a subset of the arrays of the first or second microdroplets.

48. The method according to claim 35, wherein the detection of a change in the optical signal from the merged microdroplets exceeding a pre-determined threshold level is further configured to determine the concentration of molecules or the number of molecules released from the bead.

49. The method according to claim 35, wherein the optical signal is a fluorescence signal or is a Fluorescence Resonance Energy Transfer (FRET) signal, or a Homogeneous Time Resolved Fluorescence (HTRF) signal or a luminescence signal.

50. The method according to claim 35, wherein the array of first microdroplets is provided to the microfluidic chip before the array of second microdroplets.

51. The method according to claim 35, wherein the microdroplets contain a cell media.

52. The method according to claim 35, further comprising the step of supplying a carrier fluid into the microfluidic chip.

53. The method according to claim 35, wherein the method further comprises the step of dispensing microdroplets into a well plate, wherein the droplet is selected for recovery on the basis of an optical measurement.

54. The method according to claim 53, wherein the optical measurement is conducted on a droplet which has been split from a progenitor droplet and the progenitor droplet is accordingly selected for recovery.
